(19) United States
(12) Patent Application Publication
(10) Pub. No.: US 2006/0196906 A1
(43) Pub. Date: Sep. 7, 2006

(54) Carrier for bicycles and other cargo

(76) Inventor: Verlin V. Gibson JR., Defiance, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/072,157

(22) Filed: Mar. 4, 2005

(51) Int. Cl. B60R 9/00; B60R 7/00

(52) U.S. Cl. 224/403; 224/924

(57) ABSTRACT

A cargo carrier (10) for bicycles removably installable in the bed (B) of a truck (T) has a base plate (12) which mounts on top of a sidewall (S) of the truck. The base plate extends from side of truck to the other and is secured to a top of the truck sidewalls (S) using brackets (32). This allows the front end of a bicycle or the like to be supported above the bed of the truck so there is more space available in the truck bed for carrying other cargo. A rear plate (26) for supporting the rear end of the bicycles also extends the width of the truck bed and is supported atop the sidewalls in a similar manner. When the rear plate is used, the entire bicycle is supported above the bed making substantially all the space available for carrying other cargo.

### CROSS REFERENCE TO RELATED APPLICATIONS

U.S. patent application Ser. No. 10/635,090 filed Aug. 6, 2003.

### STATEMENT REGARDING FEDERALLY SPONSORED RESEARCH OR DEVELOPMENT

N/A

### BACKGROUND OF THE INVENTION

This invention relates to the transportation of bicycles, motorcycles, and other cargo which is loaded into the bed of a pickup truck or the like, and in particular, to an improved carrier removably installed in the truck for conveniently and safely transporting bicycles and motorcycles without taking up all of the available cargo space so other cargo can be readily transported.

In pending U.S. patent application Ser. No. 10/635,090 there is described a carrier which is installed in a pickup's truck bed. Once in place, one or more bicycles or motorcycles, for example, are mounted on the carrier for safe transport from location to another. The carrier is designed so that even if difficult and rugged terrain is encountered, the bicycles or motorcycles will not be damaged are not damaged by the ride and do not damage the other vehicle or the pickup.

The carrier described in this pending application is installed on the bed of the pickup; and, as such, most of the available space is taken up when the bicycles or motorcycles are fitted in place. If other cargo is to also be transported in the pickup, the space requirements of the carrier and cycles can often limit how much additional material can be transported.

The improvement of the present invention is directed to a cargo carrier for the safe and convenient transport of bicycles, motorcycles and other objects while maximizing the amount of additional cargo which can be carried at the same time.

### BRIEF SUMMARY OF THE INVENTION

The present invention is directed to an improved cargo carrier removably installed in the bed of a pickup truck. The improved carrier comprises a front plate which extends across the bed of the truck and seats against the top of the sidewalls on the opposite sides of the truck bed. A bracket is attached to the respective sidewalls and the respective ends of the front plate attach to the brackets. This allows the carrier to be conveniently used with pickup trucks having different bed widths.

One or more saddles (for holding bikes and other articles) extend transversely of the truck bed and extend vertically upwardly from the base plate. Each saddle includes two risers, and the saddles are movable to adjust their positions relative to each other. The saddles can be offset or staggered from one another. Staggering prevents bikes from getting tangled with each other and allows them to be carried side-by-side in the back of the pickup without damaging each other.

The risers are separately movable in whichever sets of tracks they are installed so that the bikes (or other articles) of different sizes can be simultaneously carried in the back of a pickup without damaging each other. The inner surface of each riser includes pads which cushion the bikes or other articles during transport and prevent damage to them.

In a second embodiment of the invention, the improvement also includes a rear plate for securing the rear wheels of a motorcycle or bicycle, this rear plate also extending across the bed of the truck and seating against the top of the side panels on the opposite sides of the truck. This embodiment allows the bikes to be elevated completely above the truck bed allowing the entire bed to be used for storing other cargo.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a side view of a pickup truck with a first embodiment of the improved cargo carrier of the present invention installed;

FIG. 2 is a similar side view with a second embodiment of improved cargo carrier installed;

FIGS. 3 and 4 are respective top plan views of the two embodiments as installed;

FIGS. 5A-5C are respective side and rear elevation views of a front plate of the carrier, and a top plan view thereof; and,

FIG. 6 is an elevation view of a bracket used to attach the base plate to a sidewall of the truck bed.

Corresponding reference characters indicate corresponding parts throughout the several views of the drawings.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

The present invention comprises an improvement to a cargo carrier 10 such as described in my co-pending U.S. patent application Ser. No. 10/635,090, the teachings of which are incorporated herein by reference. Carrier 10 is removably installable in the bed B of a pickup truck T, and is used to transport one or more bicycles Y conveniently mounted in an upright position in the bed of the truck. Although not shown, carrier 10 is also used to transport motorcycles and other types of cargo. Carrying bicycles or motorcycles in this manner makes it move them from one from place to another without damaging them.

Carrier 10 first comprises a base plate 12 which, in accordance with the invention extends across the width of bed B with the ends of the plate seating atop the sidewalls S of the truck bed. The length of base plate 12 may, for example, be from 36-76″ so to allow the carrier to be installed in trucks having beds of different sizes. For this purpose plate 12 may be of a single piece of the appropriate length, or it may be comprised of two or more telescoping sections. The base plate has a series (eight) of spaced tracks 14 which extend lengthwise of the plate from one end to the other. The tracks are arranged in pairs 14a-14b, 14c-14d, 14e-14f, and 14g-14h and are installing saddles to the base plate.

Next, cargo carrier 10 includes at least one pair of saddles 16a-16c installed side-by-side on base plate 12. Each pair of saddles includes two spaced apart risers 18 which are installed in the slots 14 and extend vertically upwardly from the base plate. The risers 18 are curved risers whose curvature generally corresponds to that of a bicycle or motorcycle wheel. The base of each riser attaches to a base plate 12 in any convenient manner. The risers comprising each saddle are first slid along the base plate until they are appropriately positioned. Then, the risers are secured to the base plate and once locked in place, will not shift forward, backward, or sideways with respect to the base plate. Further, as shown in the drawings, if more than one saddle is installed, one set of risers can be slotted in a separate pair of tracks from the other saddles so to stagger the arrangement of bikes when they are installed on the carrier. Besides being adjustably positioned on base plate 12, 12, the positions of the risers 18 are separately adjustable once they are in place. A rod 20 extends between each riser in a pair of risers and allows the risers to be moved farther apart, or closer to, each other, so to accommodate different wheel widths. Thus, if a bicycle wheel has a slightly larger or smaller tread than expected, one or both of the risers comprising the saddle is readily adjusted to accommodate the wheel between the risers.

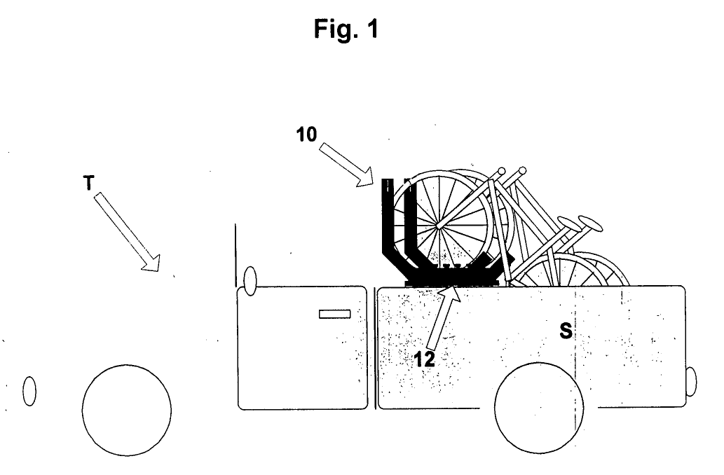

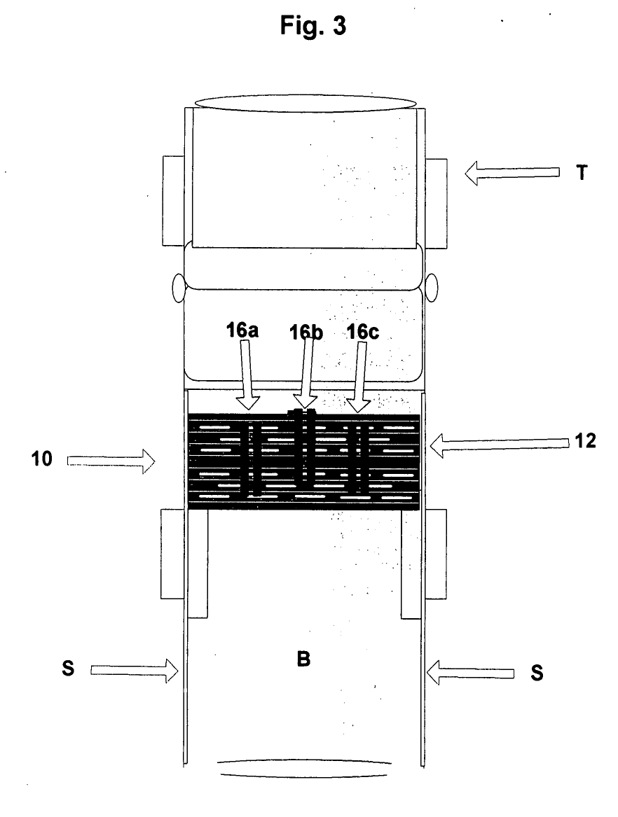

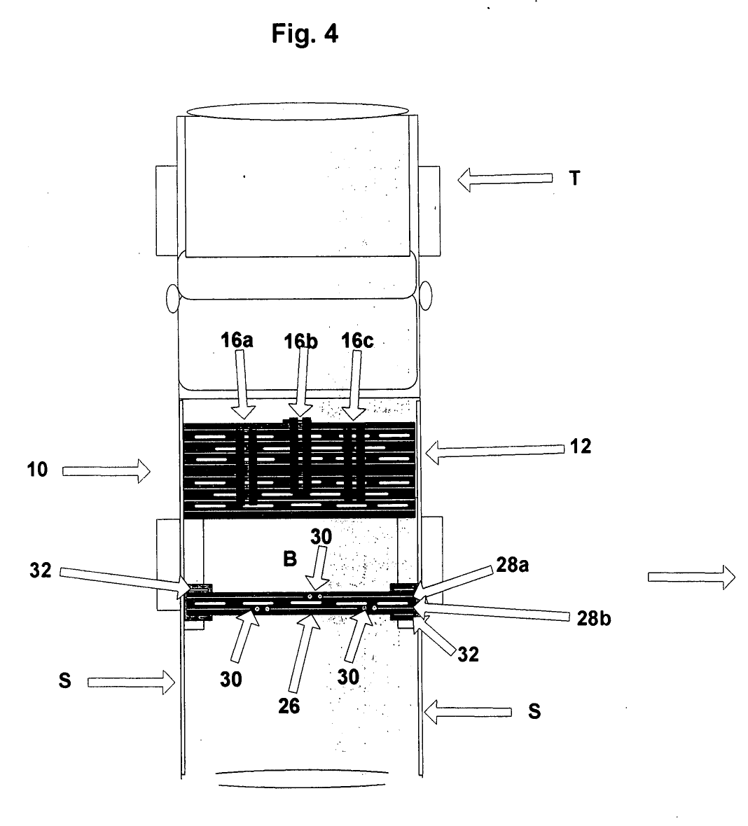

Once a wheel is in place between the risers, a cam lever 22 is depressed to clamp the wheel between the respective pair of risers. One or both of the risers may have a cushioning pad (not shown) installed on the inside face of the riser to prevent damage to a wheel. Further, each riser includes a plurality of knob-ended screws 24 which extend through the base of the riser and contact the base plate. The screws are used to dampen road vibrations, when truck T is traveling, that might otherwise cause damage to a bicycle or motorcycle installed on carrier 10.

Whereas, in the cargo described in my co-pending application Ser. No. 10/635,090, base plate 12 rested on bed B of the truck, in the improvement of my present invention, the ends of the base plate now rests atop the sidewalls of the truck bed. This is as shown in FIGS. 1-4. In the first embodiment of the invention, this elevates the front ends of the vehicles installed on carrier 10 and “frees up” the space beneath the front end of the carrier so other cargo can be stored in the truck bed. The rear wheels of the vehicles rest on the truck bed.

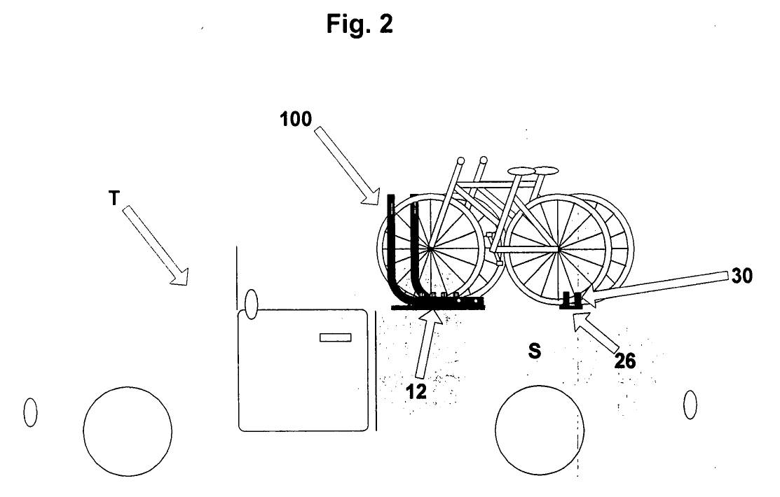

In the second embodiment of my invention, indicated generally 100 in the drawings, the rear wheels of the vehicles are mounted on a rear plate 26 which also extends the width of the truck bed with the ends of the plate resting atop the sidewalls of the truck bed. Rear plate 26 is similar in construction to base plate 10 except that it only has one pair of tracks 28a-28b extending lengthwise of the rear plate. A rear tire saddle 30 is fitted into one of these respective tracks and accommodates the rear wheel of each cycle installed on the carrier. This allows the entire vehicle to be supported above the truck bed as shown in FIG. 2. This frees up the entire bed of the truck for other cargo.

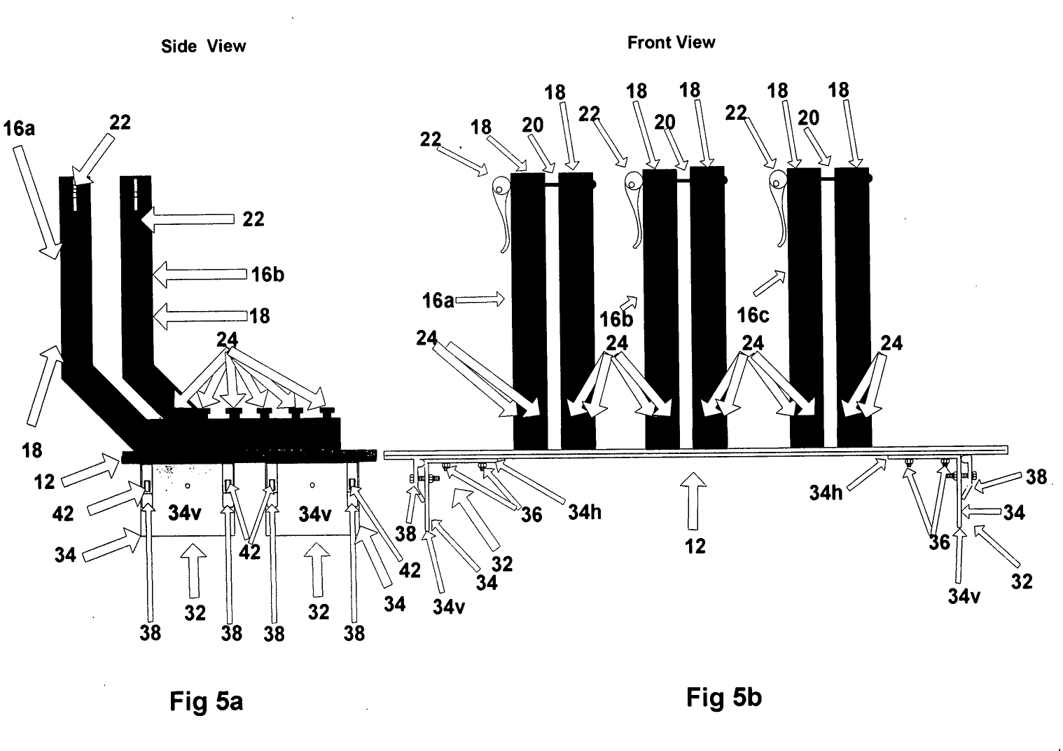

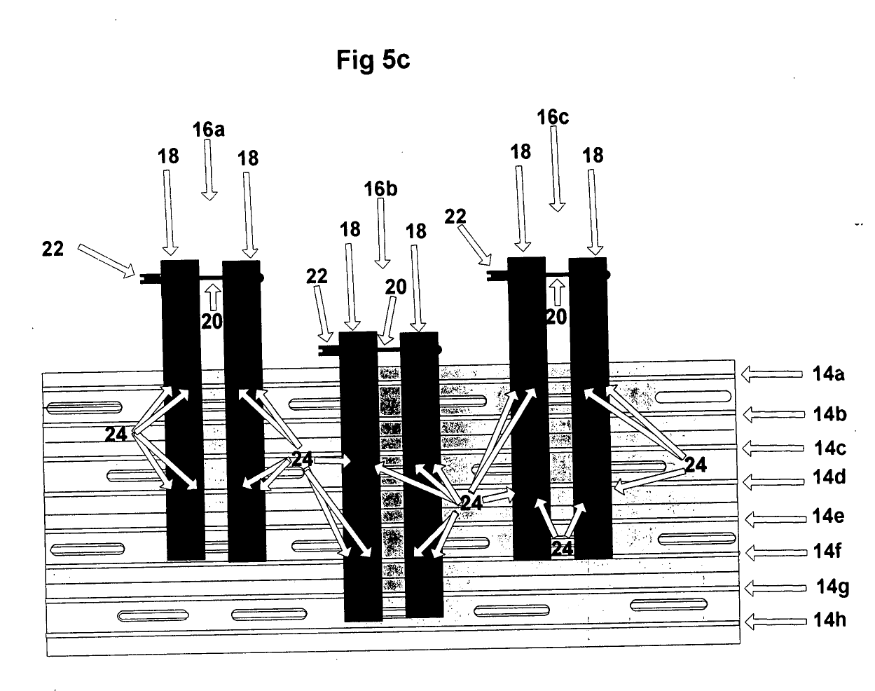

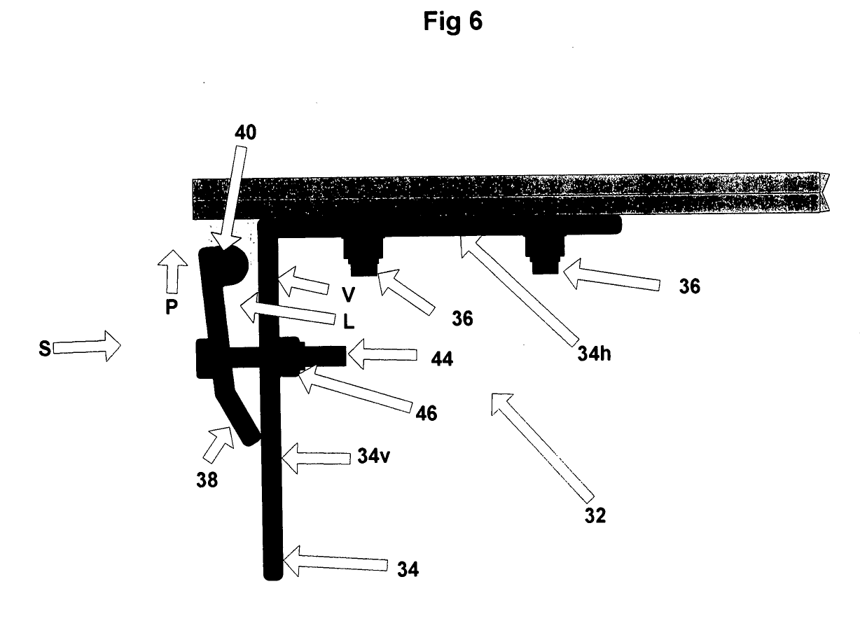

As shown in FIG. 6, the top portion P of a truck sidewall S has an inner vertical section V which extends vertically downward from the inner end of the top, and an inwardly extending lip L at the base of this vertical section. A gap is formed between the inner face of the outside portion of sidewall S, and the inner end of lip L. A support 32 for securing each end of base plate 12 and rear plate 26 to the truck includes a L-shaped bracket 34. Bracket 34 has a vertical leg 34v and a horizontal leg 34h. Two or more attachments (nuts and bolts) 36 are used to attach the horizontal section of bracket 34 to the underside of the respective base plate 12 or rear plate 26. A backing plate 38 is attached to the outer face of vertical leg 34v of the bracket, at each side of the leg as shown in FIG. 5A. A nose 40 is formed at the upper end of the backing plate. The backing plate is an angled plate whose upper, nose end is received in the space formed by the various sections P, V, and L of truck sidewall S, and whose lower end seats against the outer face of vertical leg 34v. A slot 42 is formed in the backing plate to allow the backing plate to be adjusted vertically. A bolt 44 is inserted through the slot and an opening in vertical leg 34v. A nut 46 is then fitted onto the threaded end of the bolt to tighten the bracket against the sidewall and secure the respective base plate or rear plate in place.

Cargo carrier 10 or 100 is made of wood, a heavy duty metal, or a high impact plastic. Both the base plate and rear plates can be formed in segments which detach from each other when the carrier is not in use to make it easy to store the carrier. In its disassembled form, the carrier can be stored in a bag, or small case or box in the bed of the truck, or in the truck cab for easy access.

The advantage of the cargo carrier of the present invention is its low cost, ease of assembly, disassembly, and storage, and that it makes available most or all the cargo carrying capacity of a pickup. The carrier supports a number of bikes or other articles being transported at a particular time. My improved cargo carrier further simplifies how articles being transported are arranged so to maximize the number of articles which can be transported at one time, and to do so while protecting the articles from damage. As an example, with respect to the transport of bicycles or motorcycles as earlier described, it will be noted that substantial space is still available in the bed of the truck for other equipment such as apparel, camping equipment, etc.

In view of the above, it will be seen that the several objects and advantages of the present invention have been achieved and other advantageous results have been obtained.

Having thus described the invention, what is claimed and desired to be secured by Letters Patent is:

1. A carrier (10) adapted for attachment to the sidewalls (S) of a truck (T) for transporting articles from one location to another, comprising:
a base plate (12) whose length exceeds the width of a truck bed (B) for the base plate to seat upon the respective sidewalls of the truck;
support means (32) for securing respective ends of the base plate to the truck for the base plate to be supported above the truck bed;
at least one saddle (16a-16c) fitted into the base plate for supporting one end of an article in place during transport of the article, the location of the saddle on the base plate being adjustable; and,
means (22) securing the one end of the article to the saddle for the one end of the article to be above the bed of the truck with another portion of the article resting on the truck bed.

2. The carrier of claim 1 further including a rear plate (26) whose length also exceeds the width of a truck bed for the rear plate to seat upon the respective sidewalls of the truck, the support means further securing respective ends of the rear plate to the truck for the rear plate to supported above the truck bed, a rear portion of the article being supported on the rear plate whereby the article is substantially supported above the truck bed during transport.

3. The carrier of claim 1 including a plurality of saddles each of which separately supports an article, each saddle being fitted into the base plate and adjustable therealong, the saddles being installed on the base plate with a spacing between adjacent saddles such that articles supported thereon do not interfere with each other.

4. The carrier of claim 3 wherein each saddle comprises a pair of risers with the one end of the articles being held in place between the risers.

5. The carrier of claim 1 wherein the securing means comprises a bracket attached to each end of the base plate and to the sidewall adjacent that end of the base plate.

6. The carrier of claim 5 in which the bracket comprises a L-shaped bracket whose horizontal leg is attached to an underside of the base plate and whose vertical leg extends parallel to the sidewall adjacent that end of the base plate.

7. The carrier of claim 6 in which the sidewall has a gap formed between an inner face of an outside portion of the sidewall and an inner end of a lip formed by a inwardly extending portion of the sidewall, at the upper end of the sidewall, and further including a backing plate one end of which is received in the gap, and the other end of which bears against a vertical leg of the bracket.

8. The carrier of claim 7 in which the position of the backing plate is adjustable thereby to enable the base plate to be attached to different trucks.

9. The carrier of claim 3 wherein the means securing the one end of an article to the saddle on which it is carried comprises a clamp.

10. The carrier of claim 9 further including vibration damping means on the saddle to reduce vibrations during transport of the article.

11. A carrier (10) adapted for attachment to the sidewalls (S) of a truck (T) for transporting articles from one location to another, comprising:
a base plate (12) whose length exceeds the width of a truck bed (B) for the base plate to seat upon the respective sidewalls of the truck;
a rear plate (26) whose length also exceeds the width of a truck bed for the rear plate to seat upon the respective sidewalls of the truck;
support means (32) for securing respective ends of the base plate and rear plate to the truck for the plates to be supported above the truck bed;
at least one saddle (16a-16c) fitted into the base plate for supporting one end of an article in place during transport of the article, the location of the saddle on the base plate being adjustable, the other end of the article being supported on the rear plate; and,
means (22) securing the one end of the article to the saddle whereby the article is supported above the truck bed during transport.

12. The carrier of claim 11 including a plurality of saddles each of which separately supports an article, each saddle being fitted into the base plate and adjustable therealong, the saddles being installed on the base plate with a spacing between adjacent saddles such that articles supported thereon do not interfere with each other.

13. The carrier of claim 12 wherein each saddle comprises a pair of risers with the one end of the articles being held in place between the risers.

14. The carrier of claim 11 wherein the securing means comprises a bracket attached to each end of the base plate and to the sidewall adjacent that end of the base plate.

15. The carrier of claim 14 in which the bracket comprises a L-shaped bracket whose horizontal leg is attached to an underside of the base plate and whose vertical leg extends parallel to the sidewall adjacent that end of the base plate.

16. The carrier of claim 15 in which the sidewall has a gap formed between an inner face of an outside portion of the sidewall and an inner end of a lip formed by a inwardly extending portion of the sidewall, at the upper end of the sidewall, and further including a backing plate one end of which is received in the gap, and the other end of which bears against a vertical leg of the bracket.

17. The carrier of claim 16 in which the position of the backing plate is adjustable thereby to enable the base plate to be attached to different trucks.

18. The carrier of claim 12 wherein the means securing the one end of an article to the saddle on which it is carried comprises a clamp.

19. The carrier of claim 18 further including vibration damping means on the saddle to reduce vibrations during transport of the article.
